(19) United States
(12) Patent Application Publication
(10) Pub. No.: US 2015/0354952 A1
(43) Pub. Date: Dec. 10, 2015

(54) OBJECT DISTRIBUTION ANALYSIS APPARATUS AND OBJECT DISTRIBUTION ANALYSIS METHOD

(71) Applicant: KABUSHIKI KAISHA TOSHIBA, Tokyo (JP)

(72) Inventor: Takahiro IKEDA, Yokohama Kanagawa (JP)

(73) Assignee: KABUSHIKI KAISHA TOSHIBA, Tokyo (JP)

(21) Appl. No.: 14/483,004

(22) Filed: Sep. 10, 2014

(30) Foreign Application Priority Data
Jun. 5, 2014 (JP) 2014-116883

(51) Int. Cl. G01B 21/30

(52) U.S. Cl. CPC G01B 21/30

(57) ABSTRACT

In one embodiment, an object distribution analysis apparatus includes a coordinate acquiring module configured to acquire coordinate data on plural objects, and an object pair generator configured to generate plural object pairs, each of which includes two objects among the plural objects. The apparatus further includes an azimuth calculator configured to calculate an azimuth of a line segment connecting the objects of each object pair, and a first factor calculator configured to calculate a first factor which depends on azimuths of line segments of the plural object pairs.

### CROSS REFERENCE TO RELATED APPLICATION

This application is based upon and claims the benefit of priority from the prior Japanese Patent Application No. 2014-116883, filed on Jun. 5, 2014, the entire contents of which are incorporated herein by reference.

### FIELD

Embodiments described herein relate to an object distribution analysis apparatus and an object distribution analysis method.

### BACKGROUND

When a semiconductor device is manufactured, particles and defects on a wafer affect the yield of the semiconductor device. Accordingly, particle checking and defect inspection are generally performed in various semiconductor manufacturing processes. However, it is difficult to identify why the particles and defects increase or decrease by monitoring only the increase or decrease of the number of the particles and defects. Therefore, there is used a method for examining causes of the generation and the increase or decrease of the particles and defects by conducting a feature analysis (spatial signature analysis: SSA) on the spatial point distribution of the particles and defects. However, since there are many types of the spatial point distribution of the particles and defects, it is difficult to analyze the spatial point distribution based on statistical evidence. Accordingly, analyses are visually conducted by a person in many cases.

On the other hand, there is also a demand for a method of easily knowing the spatial distribution of atoms in the analysis of atom positions using a three-dimensional atom probe. However, it is also difficult in this case to analyze the spatial distribution of the atoms based on statistical evidence. Accordingly, analyses are visually conducted through images by a person in many cases.

### BRIEF DESCRIPTION OF THE DRAWINGS

FIG. 1 is a schematic view illustrating a configuration of a failure detection system of a first embodiment;

FIG. 2 is a flowchart for describing a failure detection method of the first embodiment;

FIGS. 3A to 3C are graphs for describing the failure detection method of the first embodiment;

FIGS. 4A to 4C are schematic views for describing an Eberhardt index of the first embodiment;

FIGS. 5A and 5B are schematic views for describing particle pairs of the first embodiment;

FIG. 6 is a block diagram illustrating a configuration of a failure detection apparatus of the first embodiment;

FIG. 7 is a schematic view illustrating a configuration of a structural analysis system of a second embodiment;

FIG. 8 is a flow chart for describing a structural analysis method of the second embodiment;

FIGS. 9A to 9C are graphs for describing the structural analysis method of the second embodiment;

FIGS. 10A to 10D are schematic views illustrating examples of spatial distribution of atoms in a sample of the second embodiment;

FIG. 11 is a schematic view for describing atomic groups of the second embodiment; and

FIG. 12 is a block diagram illustrating a configuration of a structural analysis apparatus of the second embodiment.

### DETAILED DESCRIPTION

Embodiments will now be explained with reference to the accompanying drawings.

In one embodiment, an object distribution analysis apparatus includes a coordinate acquiring module configured to acquire coordinate data on plural objects, and an object pair generator configured to generate plural object pairs, each of which includes two objects among the plural objects. The apparatus further includes an azimuth calculator configured to calculate an azimuth of a line segment connecting the objects of each object pair, and a first factor calculator configured to calculate a first factor which depends on azimuths of line segments of the plural object pairs.

### First Embodiment

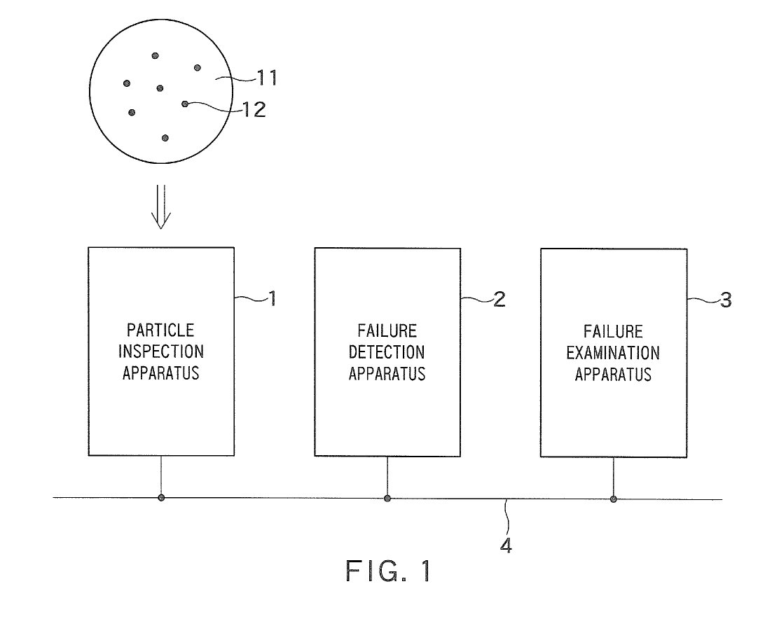

FIG. 1 is a schematic view illustrating a configuration of a failure detection system of a first embodiment.

The failure detection system of FIG. 1 includes a particle inspection apparatus 1, a failure detection apparatus 2 as an example of an object distribution analysis apparatus, a failure examination apparatus 3, and a network 4 interconnecting these apparatuses.

In the present embodiment, a wafer 11 is sampled in a semiconductor manufacturing process to inspect particles 12 on the wafer 11 using the particle inspection apparatus 1. The particles 12 are an example of objects to be analyzed using the object distribution analysis apparatus. The particle inspection apparatus 1 measures space coordinates of the particles 12, and outputs space coordinate data on the particles 12 to the failure detection apparatus 2. The failure detection apparatus 2 detects failures of the wafer 11 based on the space coordinate data on the particles 12. The failures of the wafer 11 detected by the failure detection apparatus 2 are examined in detail by the failure examination apparatus 3.

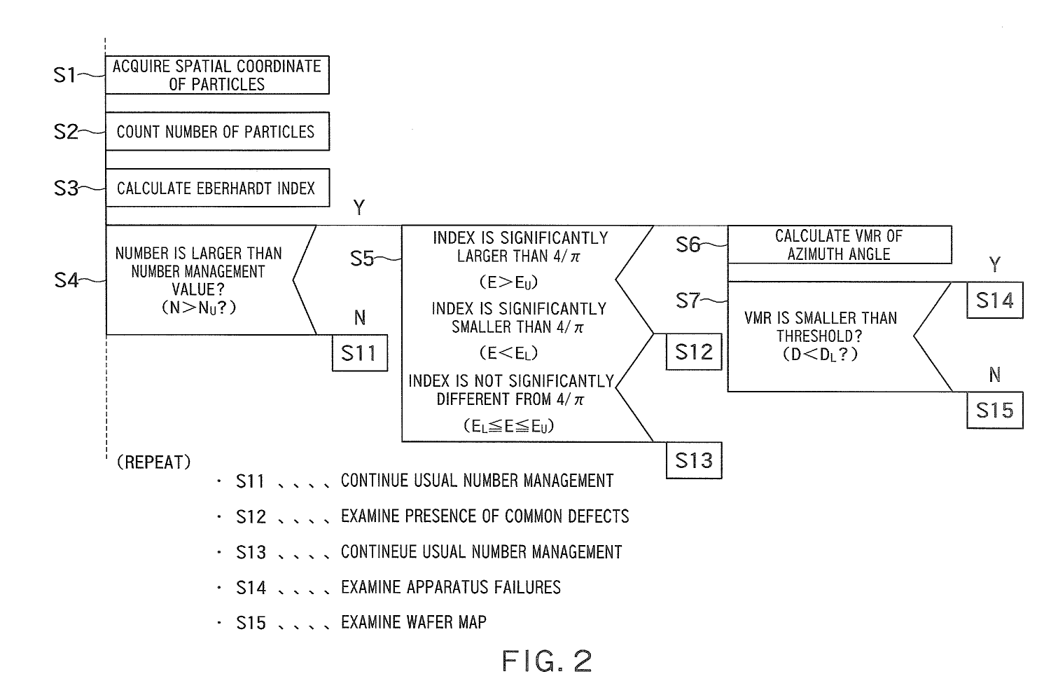

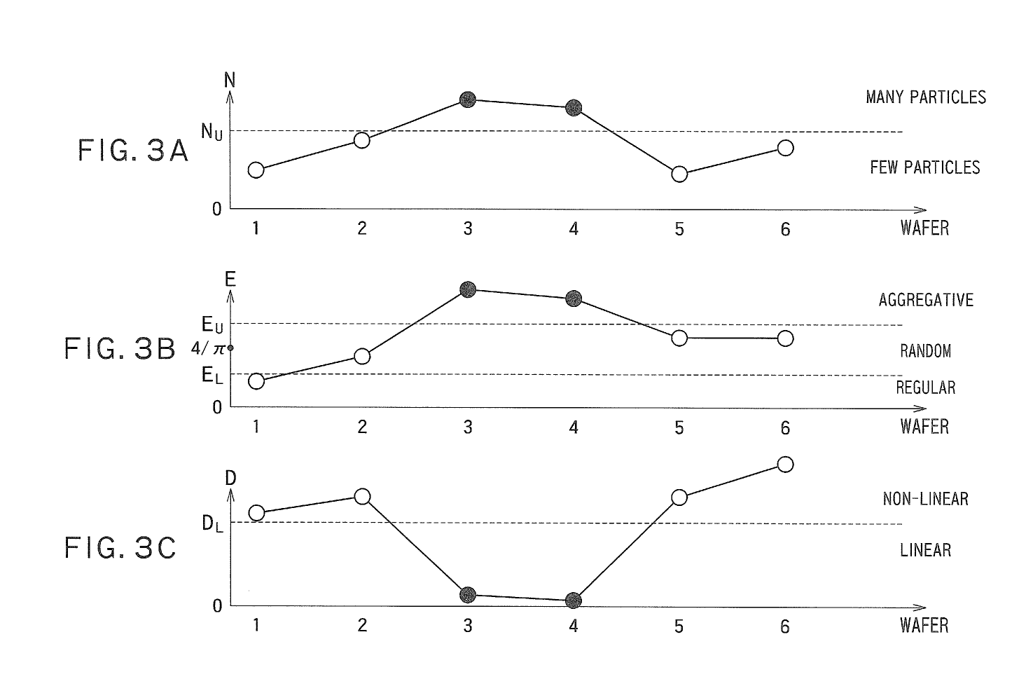

FIG. 2 is a flowchart for describing a failure detection method of the first embodiment. FIGS. 3A to 3C are graphs for describing the failure detection method of the first embodiment.

The failure detection method of the present embodiment is carried out by the failure detection apparatus 2.

The failure detection method of the present embodiment will be described with reference to FIG. 2.

[Step S1]

First, the space coordinate data on the particles 12 on the wafer 11 is acquired from the particle inspection apparatus 1 (step S1). For example, the space coordinate data includes the X-coordinate and the Y-coordinate of each particle 12.

[Step S2]

Next, the number of the particles 12 detected on the wafer 11 is counted to plot this count value on such a first control chart as illustrated in FIG. 3A (step S2). The numbers of the particles 12 on plural wafers 11 are collectively plotted on the first control chart. FIG. 3A shows examples of the numbers N of the particles 12 on six wafers 11.

[Step S3]

Next, an Eberhardt index is calculated based on the space coordinate data on the particles 12 to plot this calculation value on such a second control chart as illustrated in FIG. 3B (step S3). Eberhardt indices of plural wafers 11 are collectively plotted on the second control chart. FIG. 3B shows examples of the Eberhardt indices E of six wafers 11.

The Eberhardt index E of the wafer 11 having the N particles 12 is expressed by Equation (1) shown below:

$$E = \frac{N {\sum }_{i = 1}^{N} {d}_{i}^{2}}{{( {\sum }_{i = 1}^{N} {d}_{i} )}^{2}} \qquad ( 1 )$$

where “dᵢ” is a distance between an i-th particle 12 and its closest particle 12 (nearest neighbor distance).

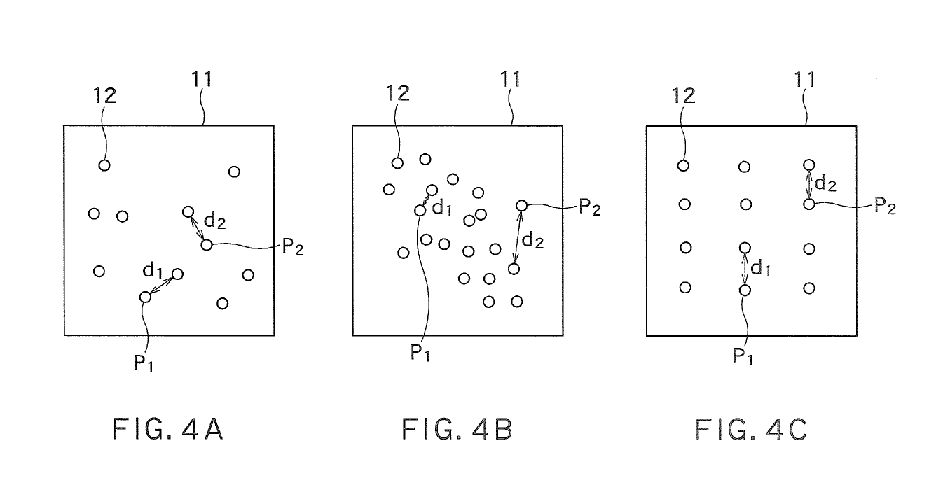

FIGS. 4A to 4C are schematic views for describing the Eberhardt index E of the first embodiment. Reference character d₁ denotes the nearest neighbor distance of a first particle P₁.

Reference character d₂ denotes the nearest neighbor distance of a second particle P₂.

FIG. 4A shows a case where the spatial point distribution of the particles 12 is random (Poisson-like). In this case, the Eberhardt index E basically coincides with 4/π.

FIG. 4B shows a case where the spatial point distribution of the particles 12 is aggregative, and clusters of the particles 12 exist. In this case, the Eberhardt index E is larger than 4/π.

FIG. 4C shows a case where the spatial point distribution of the particles 12 is regular, and the nearest neighbor distances of the particles 12 are nearly even. In this case, the Eberhardt index E is smaller than 4/π.

The failure detection method of the present embodiment will be described further by referring back to FIG. 2.

[Step S4]

The number N of the particles 12 is compared to a predetermined number management value N_{U} to determine whether or not the number N exceeds the number management value N_{U} (step S4). The number management value N_{U} is an example of a threshold to be compared with the number N.

If the number N is larger than the number management value N_{U} (N>N_{U}), a large number of particles 12 are present on the wafer 11 (FIG. 3A), and therefore the wafer 11 is highly likely to include failures. Accordingly, the system moves to step S5 in order to perform a further failure detection process.

On the other hand, if the number N is equal to or smaller than the number management value N_{U} (N≦N_{U}), only a small number of particles 12 are present on the wafer 11 (FIG. 3A), and therefore the wafer 11 is less likely to include failures. Accordingly, the system continues usual particle number management (step S11).

[Step S5]

It is determined whether the Eberhardt index E is significantly larger or smaller than 4/π (step S5). Specifically, the Eberhardt index E is compared with a predetermined upper limit E_{U} and a predetermined lower limit E_{L} to determine whether or not the Eberhardt index E is larger than the upper limit E_{U} and whether or not the Eberhardt index E is smaller than the lower limit E_{L}. The upper limit E_{U} and the lower limit E_{L} are examples of one or more thresholds to be compared with the Eberhardt index.

The upper limit E_{U} of the present embodiment is a value larger than 4/π (FIG. 3B). For example, the upper limit E_{U} is set so that the ratio of wafers 11 whose Eberhardt indices E are larger than the upper limit E_{U} is 5% in a case where the distribution of the Eberhardt indices E of the wafers 11 is assumed to be a distribution described in the paper by W. G. S. Heynes and R. J. O'H. Heynes “The Eberhardt statistic, and the detection of non-randomness of spatial point distribution and analysis of distribution patterns”, Biometrika, 66, 73-39(1979).

On the other hand, the lower limit E_{L} of the present embodiment is a value smaller than 4/π (FIG. 3B). For example, the lower limit E_{L} is set so that the ratio of wafers 11 whose Eberhardt indices E are smaller than the lower limit E_{L} is 5% in a case where the distribution of the Eberhardt indices E of the wafers 11 is assumed to be the distribution described above.

If the Eberhardt index E is larger than the upper limit E_{U} (E>EU), the spatial point distribution of the particles 12 is aggregative (FIG. 3B). In this case, the particles 12 may be intensively generated at a certain place since semiconductor manufacturing apparatuses include some failures, thereby possibly giving rise to the clusters. Accordingly, the system moves to step S6 in order to identify apparatus failures.

On the other hand, if the Eberhardt index E is smaller than the lower limit E_{L} (E<EL), the spatial point distribution of the particles 12 is regular (FIG. 3B). In this case, there may be common defects such as failures in a photomask, which cause the particles 12 to be generated in a regular manner. Accordingly, the presence and absence of the common defects are examined using the failure examination apparatus 3 or the like (step S12).

If the Eberhardt index E is equal to or smaller than the upper limit E_{U} and equal to or larger than the lower limit E_{L} (E_{L}≦E≦E_{U}), the spatial point distribution of the particles 12 is random (FIG. 3B). In this case, although a large number of particles 12 are present on the wafer 11, any specific unit of the semiconductor manufacturing apparatuses or semiconductor manufacturing processes is unlikely to include failures. Accordingly, the system continues usual particle number management (step S13).

[Step S6]

Next, two particles 12 are selected from the particles 12 on the wafer 11 to specify them as a particle pair. In this way, there are generated plural particle pairs, each of which includes two particles 12 (step S6).

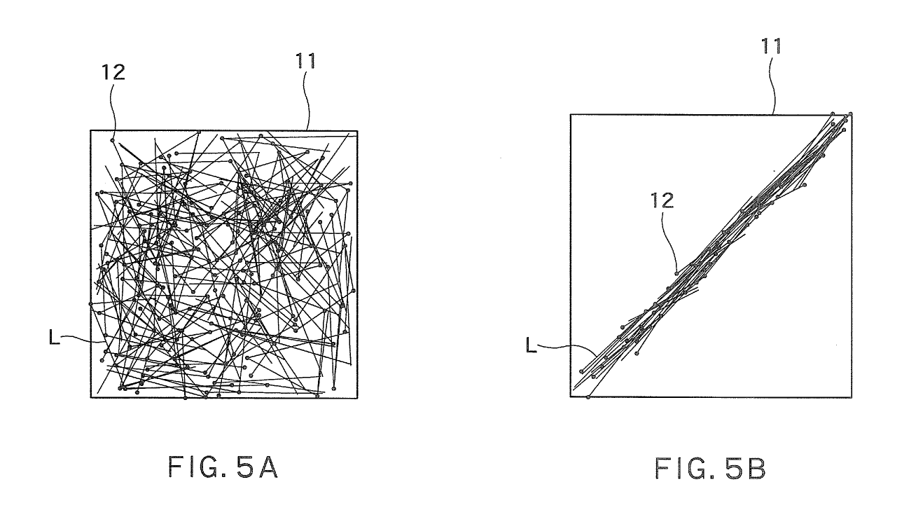

FIGS. 5A and 5B are schematic views for describing the particle pairs of the first embodiment. Reference character L denotes line segments connecting the particles 12 which form the particle pairs.

The particle pairs of the present embodiment are generated by searching for a Kth-order neighbor point of each particle 12 where K is an integer of one or more. The Kth-order neighbor point means a particle 12 which is Kth closest to each particle 12. Accordingly, a distance between each particle 12 and its first-order neighbor point corresponds to the nearest neighbor distance “dᵢ”. In the present embodiment, each particle 12 and its first-order to hundredth-order neighbor points are formed into the particle pairs, thereby generating the plural particle pairs. This value of hundredth order may be replaced with another value. FIGS. 5A and 5B show the particle pairs, each of which includes of a particle 12 and its hundredth-order neighbor point.

The search of the Kth-order neighbor point in the present embodiment is made simultaneously with the calculation of the Eberhardt index E. The Kth-order neighbor point can be searched by calculating the distances between each particle 12 and its neighbor points based on the space coordinate data, comparing these distances among the neighbor points of each particle 12, and finding a neighbor point whose distance is Kth-smallest.

Next, an azimuth of a line segments L connecting the particles 12 of each particle pair is calculated (step S6). Specifically, an azimuth angle of the line segment L is calculated. Hereinafter, this azimuth angle is denoted by reference character θ.

Next, the mean and the variance of the azimuth angles θ of the particle pairs on the wafer 11 are calculated to calculate the variance/mean ratio (VMR) of these particle pairs (step S6). This value is plotted on such a third control chart as illustrated in FIG. 3C. The variance/mean ratios of the azimuth angles θ in plural wafers 11 are collectively plotted on the third control chart. FIG. 3C shows an example of the variance/mean ratios D of the azimuth angles θ in six wafers 11. The variance/mean ratio D is an example of a first factor which depends on azimuths of plural object pairs.

A description will now be made of the difference between FIGS. 5A and 5B.

The Eberhardt indices E of FIGS. 5A and 5B are 1.30 and 1.44, respectively. These Eberhardt indices E of are larger than 4/n. Therefore, the spatial point distributions of the particles 12 of FIGS. 5A and 5B are aggregative.

However, the particles 12 of FIG. 5B distribute in a linear manner whereas the particles 12 of FIG. 5A distribute in a planar manner. Accordingly, the azimuth angles θ are large in variation in FIG. 5A, and therefore the variance/mean ratio D is large in FIG. 5A. On the other hand, the azimuth angles θ are small in variation in FIG. 5B, and therefore the variance/mean ratio D is small in FIG. 5B. The variance/mean ratios D of FIGS. 5A and 5B are 1882.3 and 0.015, respectively.

The failure detection method of the present embodiment will be described further by referring back to FIG. 2.

[Step S7]

The variance/mean ratio D of the azimuth angles θ is compared to a predetermined threshold D_{L} to determine whether or not the variance/mean ratio D underruns the threshold D_{L} (step S7). The system then executes a process according to a result of the comparison between these values, such as displaying the result the comparison on a screen. The threshold D_{L} is an example of a first threshold.

If the variance/mean ratio D is smaller than the threshold D_{L} (D<D_{L}), the spatial point distribution of the particles 12 is linear. In this case, apparatus failures which can be a cause for scratches or radial defects may have occurred in a chemical mechanical polishing (CMP) process or a lithography process. Accordingly, the apparatus failures are inspected in the chemical mechanical polishing process or the lithography process using the failure examination apparatus 3 or the like (step S14). In addition, the comparison result showing that the spatial point distribution of the particles 12 is linear may be displayed on the screen to prompt an administrator to conduct such an inspection.

On the other hand, if the variance/mean ratio D is greater than the threshold D_{L} (D≧DL), the spatial point distribution of the particles 12 is nonlinear. In this case, the apparatus failures may have occurred in other processes. Accordingly, a wafer map is inspected in detail in order to identify a cause for the failures (step S15). In addition, the comparison result showing that the spatial point distribution of the particles 12 is nonlinear may be displayed on the screen to prompt the administrator to conduct such an inspection.

For example, the threshold D_{L} can be calculated as a probability point in the case where the spatial point distribution of the particles 12 is nonlinear. The threshold D_{L} of the present embodiment is calculated by making a Monte Carlo calculation of calculating a 95% confidence limit in a case where the spatial point distribution of the particles 12 is nonlinear.

In steps S11 and S13 of the present embodiment, a trend analysis may also be conducted on the Eberhardt indices E and the variance/mean ratios D, while continuing usual number management. For example, analyses may be made as to whether the Eberhardt indices E and the variance/mean ratios D continuously exhibit an rising trend or a falling trend, whether the Eberhardt indices E continuously overrun the upper limit E_{U}, whether the Eberhardt indices E continuously underrun the lower limit E_{L}, whether the variance/mean ratios D continuously overrun the threshold D_{L}, and whether the Eberhardt indices E and the variance/mean ratios D increase and decrease alternately.

[Failure Detection Apparatus 2 of First Embodiment]

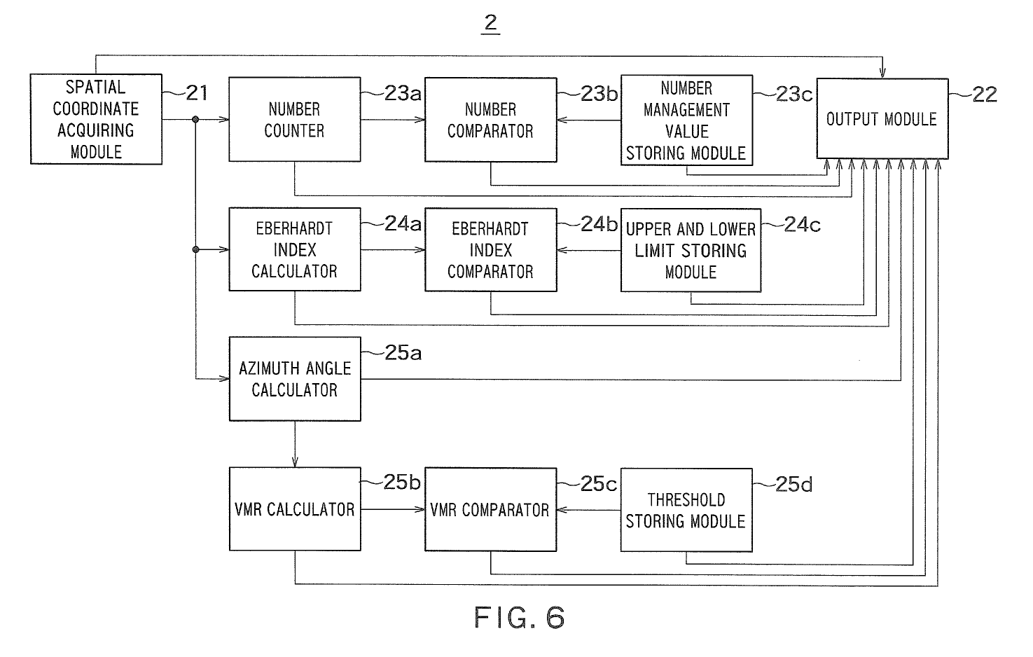

FIG. 6 is a block diagram illustrating a configuration of the failure detection apparatus 2 of the first embodiment.

The failure detection apparatus 2 of the present embodiment includes a space coordinate acquiring module 21 as an example of a coordinate acquiring module, an output module 22, a number counter 23a, a number comparator 23b, a number management value storing module 23c, an Eberhardt index calculator 24a, an Eberhardt index comparator 24b and an upper and lower limit storing module 24c.

The failure detection apparatus 2 of the present embodiment further includes an azimuth angle calculator 25a as an example of an object pair generator and an azimuth calculator, a VMR calculator 25b as an example of a first factor calculator, a VMR comparator 25c as an example of a first comparator, and a threshold storing module 25d.

The space coordinate acquiring module 21 acquires the space coordinate data on the particles 12 on the wafer 11 in step S1.

The number counter 23a counts the number N of the particles 12 on the wafer 11 in step S2. The number comparator 23b compares the number N and the number management value N_{U} stored in the number management value storing module 23c in step S4, and executes the process according to the result of the comparison between these values. For example, the number comparator 23b displays the result of the comparison between the number N and the number management value N_{U} on the screen through the output module 22.

The Eberhardt index calculator 24a calculates the Eberhardt index E of the particles 12 on the wafer 11 in step S3. The Eberhardt index comparator 24b compares the Eberhardt index E and the upper and lower limits E_{U} and E_{L} stored in the upper and lower limit storing module 24c in step S5, and executes the process according to the result of the comparison between these values. For example, the Eberhardt index comparator 24b displays the result of the comparison between the Eberhardt index E and the upper and lower limits E_{U} and E_{L} on the screen through the output module 22.

The azimuth angle calculator 25a generates the plural particle pairs in step S6, and calculates the azimuth angle θ of the line segment L connecting the particles 12 of each particle pair. The VMR calculator 25b calculates the variance/mean ratio (VMR) D of the azimuth angles θ in step S6. The VMR comparator 25c compares the variance/mean ratio D and the threshold D_{L} stored in the threshold storing module 25d in step S7, and executes the process according to the result of the comparison between these values. For example, the VMR comparator 25c displays the result of the comparison between the variance/mean ratio D and the threshold D_{L} on the screen through the output module 22.

The output module 22 outputs data received from these blocks. For example, the output module 22 may display the data received from these blocks on the screen, may store the data in a storage device, or may transmit the data to the outside through a communications device.

As described above, the present embodiment generates the plural particle pairs, calculates the variance/mean ratio D of the azimuth angles θ of these particle pairs, and uses the variance/mean ratio D to analyze the distribution of the particles 12.

Therefore, the present embodiment makes it possible to analyze the spatial point distribution of the particles 12 based on statistical evidence, specifically, makes it possible to discriminate between a linear distribution and a nonlinear distribution by the variance/mean ratio D of the azimuth angles θ. Consequently, the present embodiment makes it possible to accurately detect problems with the semiconductor manufacturing apparatuses, semiconductor manufacturing processes, and materials such as the apparatus failures in the chemical mechanical polishing process or the lithography process which can be the cause for the scratches or radial defects.

In the present embodiment, defects on the wafer 11 may be analyzed instead of the particles 12 on the wafer 11.

In the present embodiment, each particle 12 and all of the first-order to hundredth-order neighbor points need not necessarily be formed into the particle pairs. Instead, each particle 12 and only some of the first-order to hundredth-order neighbor points may be formed into the particle pairs. For example, neighbor points of only odd orders such as first-order, third-order and fifth-order neighbor points may be included in the particle pairs. Alternatively, only neighbor points of high orders such as fifty-first-order to hundredth-order neighbor points may be included in the particle pairs.

### Second Embodiment

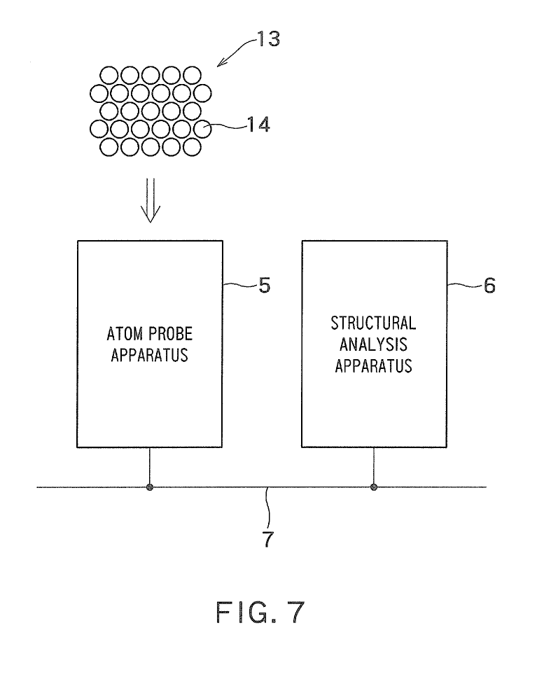

FIG. 7 is a schematic view illustrating a configuration of a structural analysis system of a second embodiment.

The structural analysis system of FIG. 7 includes an atom probe apparatus 5, a structural analysis apparatus 6 as an example of the object distribution analysis apparatus, and a network 7 for interconnecting these apparatuses.

The atom probe apparatus 5 measures spatial distribution of atoms 14 in a sample 13 having a minute structure with a three-dimensional atom probe which applies the principles of a field ion microscope (FIM). The atoms 14 in the sample 13 are an example of the objects to be analyzed by the object distribution analysis apparatus. The atom probe apparatus 5 identifies the original spatial distribution of the atoms 14 in the sample 13 by applying a high electric field in vacuum to the sample 13 shaped into a needle shape and analyzing the trajectories of the atoms 14 emitted from the sample 13 as ions. The atom probe apparatus 5 measures space coordinates of the atoms 14 in the sample 13 to output space coordinate data on the atoms 14 to the structural analysis apparatus 6.

The structural analysis apparatus 6 determines the type of the spatial distribution of the atoms 14 based on the space coordinate data on the atoms 14. For example, the structural analysis apparatus 6 can determine the spatial distribution of the specific atoms 14 in the sample 13 to be random, aggregative or regular. A method of determining these types is the same as the method in the first embodiment. Examples of the specific atoms 14 in the sample 13 include impurity atoms in a case where the sample 13 is silicon. In addition, the structural analysis apparatus 6 can determine whether or not the spatial distribution of the specific atoms 14 is linear and whether or not the spatial distribution of the specific atoms 14 is planar in a case where the spatial distribution of the specific atoms 14 is aggregative. A method of determining a linear distribution is the same as the method in the first embodiment. A method of determining a planar distribution will be described later.

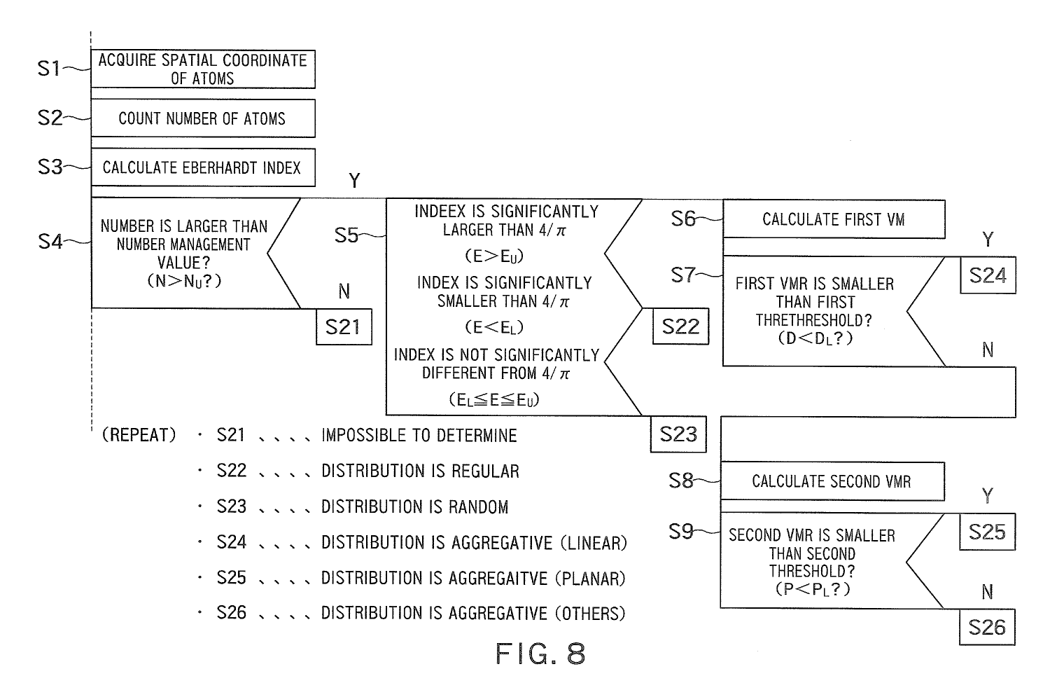

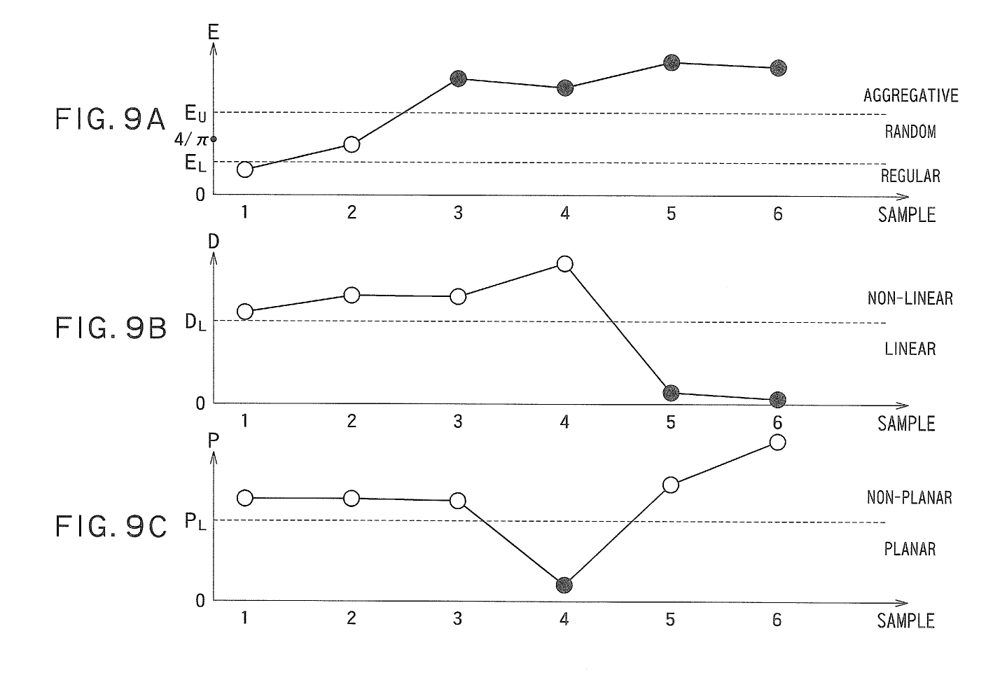

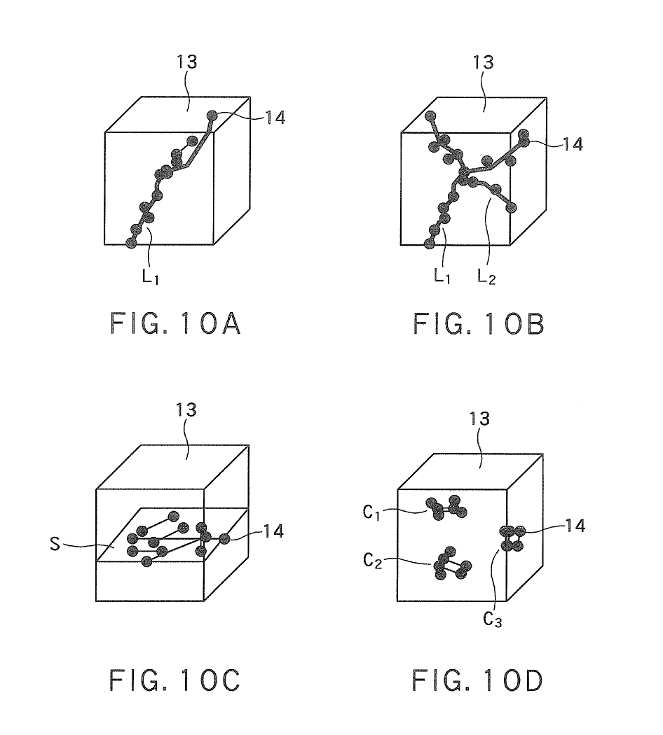

FIG. 8 is a flow chart for describing a structural analysis method of the second embodiment. FIGS. 9A to 9C are graphs for describing the structural analysis method of the second embodiment. FIGS. 10A to 10D are schematic views illustrating examples of the spatial distribution of the atoms 14 in the sample 13 of the second embodiment. The structural analysis method of the present embodiment is carried out by the structural analysis apparatus 6.

The structural analysis method of the present embodiment will be described with reference to FIG. 8.

[Step S1]

First, the space coordinate data on the atoms 14 in the sample 13 is acquired from the atom probe apparatus 5 (step S1). For example, the space coordinate data includes the X-coordinate, Y-coordinate and Z-coordinate of each atom 14.

[Step S2]

Next, the number of the specific atoms 14 in the sample 13 is counted to plot this count value on the first control chart (step S2). The numbers of the specific atoms 14 in plural samples 13 are collectively plotted on the first control chart.

[Step S3]

Next, an Eberhardt index is calculated based on the space coordinate data on the specific atoms 14 to plot this calculation value on such a second control chart as illustrated in FIG. 9A (step S3). Eberhardt indices in plural samples 13 are collectively plotted on the second control chart. FIG. 9A shows examples of the Eberhardt indices E in six samples 13.

[Step S4]

The number N of the specific atoms 14 is compared to a predetermined number management value N_{U} to determine whether or not the number N exceeds the number management value N_{U} (step S4).

If the number N is larger than the number management value N_{U} (N>N_{U}), the specific atoms 14 whose number N is large enough to determine the type of the spatial distribution exist. Accordingly, the system moves to step S5 in order to determine the type of the spatial distribution of these atoms 14.

On the other hand, if the number N is equal to or smaller than the number management value N_{U} (N≦N_{U}), the specific atoms 14 whose number N is large enough to determine the type of spatial distribution do not exist. Accordingly, the system decides that the type of the spatial distribution of these atoms 14 is impossible to determine (step S21).

[Step S5]

It is determined whether the Eberhardt index E is significantly larger or smaller than 4/π (step S5). Specifically, the Eberhardt index E is compared with a predetermined upper limit E_{U} and a predetermined lower limit E_{L} to determine whether or not the Eberhardt index E is larger than the upper limit E_{U} and whether or not the Eberhardt index E is smaller than the lower limit E_{L}.

If the Eberhardt index E is larger than the upper limit E_{U} (E>EU), the spatial distribution of the specific atoms 14 is aggregative (FIG. 9A). In this case, the system moves to step S6 in order to further identify the type of the spatial distribution of these atoms 14.

On the other hand, if the Eberhardt index E is smaller than the lower limit E_{L} (E<EL), the spatial distribution of the specific atoms 14 is regular (FIG. 9A). In this case, the spatial distribution of these atoms 14 is determined to be regular (step S22). Each first sample 13 in FIGS. 9A to 9C is an example of such a sample 13.

If the Eberhardt index E is equal to or smaller than the upper limit E_{U} and equal to or larger than the lower limit E_{L} (E_{L}≦E≦E_{U}), the spatial distribution of the specific atoms 14 is random (FIG. 9A). In this case, the spatial distribution of these atoms 14 is determined to be random (step S23). Each second sample 13 in FIGS. 9A to 9C is an example of such a sample 13.

[Step S6]

Next, two atoms 14 are selected from the specific atoms 14 in the sample 13 to specify them as an atom pair. In this way, there generated plural atom pairs, each of which includes two atoms 14 (step S6).

The atom pairs of the present embodiment are generated by searching for a Kth-order neighbor point of each atom 14 where K is an integer of one or more. The Kth-order neighbor point means an atom 14 which is Kth closest to each atom 14. In the present embodiment, each atom 14 and its first-order to hundredth-order neighbor points are formed into the atom pairs, thereby generating the plural atom pairs. This value of hundredth order may be replaced with another value.

Next, an azimuth of a line segment (line segment azimuth) connecting the atoms 14 of each atom pair is calculated (step S6). Specifically, values of variables representing the line segment azimuth of each atom pair (for example, polar coordinates θ and φ) are calculated.

Next, the mean and the variance of the line segment azimuths of the atom pairs in the sample 13 are calculated to calculate the variance/mean ratio (VMR) of these atom pairs (step S6). This value is plotted on such a third control chart as illustrated in FIG. 9B. The variance/mean ratios of the line segment azimuths in plural samples 13 are collectively plotted on the third control chart. FIG. 9B shows examples of the variance/mean ratios D of the line segment azimuths in six samples 13. The variance/mean ratio D is an example of a first factor which depends on the azimuths of the plural object pairs.

Hereinafter, the variance/mean ratio D is referred to as “first variance/mean ratio D” in order to discriminate this variance/mean ratio D from another variance/mean ratio described later.

[Step S7]

The first variance/mean ratio D is compared to a predetermined first threshold D_{L} to determine whether or not the first variance/mean ratio D underruns the first threshold D_{L} (step S7). The system then executes a process according to a result of the comparison between these values, such as displaying the result of the comparison on a screen.

If the first variance/mean ratio D is smaller than the first threshold D_{L} (D<D_{L}), the spatial distribution of the specific atoms 14 is linear. In this case, the spatial distribution of these atoms 14 is determined to be linear (step S24). In addition, the comparison result showing that the spatial distribution of these atoms 14 is linear may be displayed on the screen. Sixth and fifth samples 13 in FIGS. 9A to 9C are examples of such samples 13. The atoms 14 in the sixth sample 13 are distributed on a single line L₁ as illustrated in FIG. 10A, whereas the atoms 14 in the fifth sample 13 are distributed on plural lines L₁ and L₂ as illustrated in FIG. 10B. On the other hand, if the first variance/mean ratio D is greater than the first threshold D_{L} (D≧DL), the spatial distribution of the specific atoms 14 is nonlinear. In this case, the system moves to step 8 in order to further identify the type of spatial distribution of these atoms 14.

[Step S8]

Next, three atoms 14 are selected from the specific atoms 14 in the sample 13 to specify them as an atomic group. In this way, there generated plural atomic groups, each of which includes three atoms 14 (step S8).

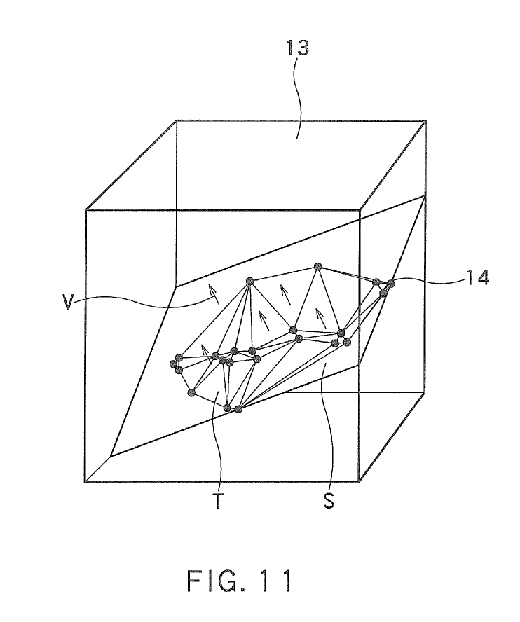

FIG. 11 is a schematic view for describing the atomic groups of the second embodiment.

Reference character T denotes triangles formed by the atoms 14 belonging to the same atomic group. Each triangle T in FIG. 11 is a Delaunay triangle. The Delaunay triangle is a graphic used for mesh generation in a finite element method and the like. It is known that when plural triangles are generated by selecting three points from the plural points, the plural triangles can be uniquely generated from the plural points, assuming that the triangles are Delaunay triangles. The Delaunay triangles are generated based on the proximity relationship of points. In the present embodiment, the plural atomic groups are generated by defining the atoms 14 forming the same Delaunay triangle as an atomic group.

Next, a normal direction of a triangle T formed by the atoms 14 of each atomic group is calculated (step S8). Specifically, variables representing a direction of a normal vector V of each triangle T (for example, θ and φ components of the normal vector V) are calculated.

Next, the mean and the variance of the atomic groups in the sample 13 are calculated to calculate the variance/mean ratio (VMR) of the normal directions of these atomic groups. This value is plotted on such a fourth control chart as illustrated in FIG. 9C (step S8). The variance/mean ratios of the normal directions in plural samples 13 are collectively plotted on the fourth control chart. FIG. 9C shows examples of the variance/mean ratios P of the normal directions in six samples 13. The variance/mean ratio P is an example of a second factor which depends on normal directions of plural object groups.

Hereinafter, the variance/mean ratio P is referred to as “second variance/mean ratio P” in order to discriminate this variance/mean ratio P from the first variance/mean ratio D.

Paying attention here to the spatial distribution of the atoms 14 in the sample 13 in FIG. 11 reveals that these atoms 14 distribute in a planar manner on almost the same plane S. Accordingly, a variation in the directions of the normal vectors V is small in FIG. 11, and therefore the second variance/mean ratio P is low. In this way, the second variance/mean ratio P can be used as a criterion as to whether or not the spatial distribution of the atoms 14 is planar.

The structural analysis method of the present embodiment will be described further by referring back to FIG. 8.

[Step S9]

The second variance/mean ratio P is compared to a predetermined second threshold P_{L} to determine whether or not the second variance/mean ratio P underruns the second threshold P_{L} (step S9). The system then executes a process according to a result of the comparison between these values, such as displaying the result on the screen.

If the second variance/mean ratio P is smaller than the second threshold P_{L} (P<P_{L}), the spatial distribution of the specific atoms 14 is planar. In this case, the spatial distribution of these atoms 14 is determined to be planar (step S25). In addition, the comparison result showing that the spatial distribution of these atoms 14 is planar may be displayed on the screen. Each fourth sample 13 in FIGS. 9A to 9C is an example of such a sample 13. The atoms 14 in the fourth sample 13 distribute on a plane S, as illustrated in FIG. 10C.

On the other hand, if the second variance/mean ratio P is equal to or greater than the second threshold P_{L} (P≧P_{L}), the spatial distribution of the specific atoms 14 is nonlinear and non-planar. In this case, the spatial distribution of these atoms 14 is determined to be aggregative but nonlinear and non-planar (step S26). In addition, this comparison result may be displayed on the screen. Each third sample 13 in FIGS. 9A to 9C is an example of such a sample 13. For example, the atoms 14 in the third sample 13 distribute in a point-like manner as shown by points C₁, C₂ and C₃ in FIG. 10D.

It is noted that the second variance/mean ratio P of the fifth sample 13 (FIG. 10B) is lower than the second variance/mean ratio P of the sixth sample 13 (FIG. 10A). The reason for this is that the distribution of atoms 14 in the fifth sample 13 is closer to a plane than the distribution of atoms 14 in the sixth sample 13.

For example, the second threshold P_{L} can be calculated a probability point in a case where the spatial distribution of the atoms 14 is non-planar. The second threshold P_{L} of the present embodiment is calculated by making a Monte Carlo calculation of calculating a 95% confidence limit in a case where the spatial distribution of the atoms 14 is non-planar.

[Structural Analysis Apparatus 6 of Second Embodiment]

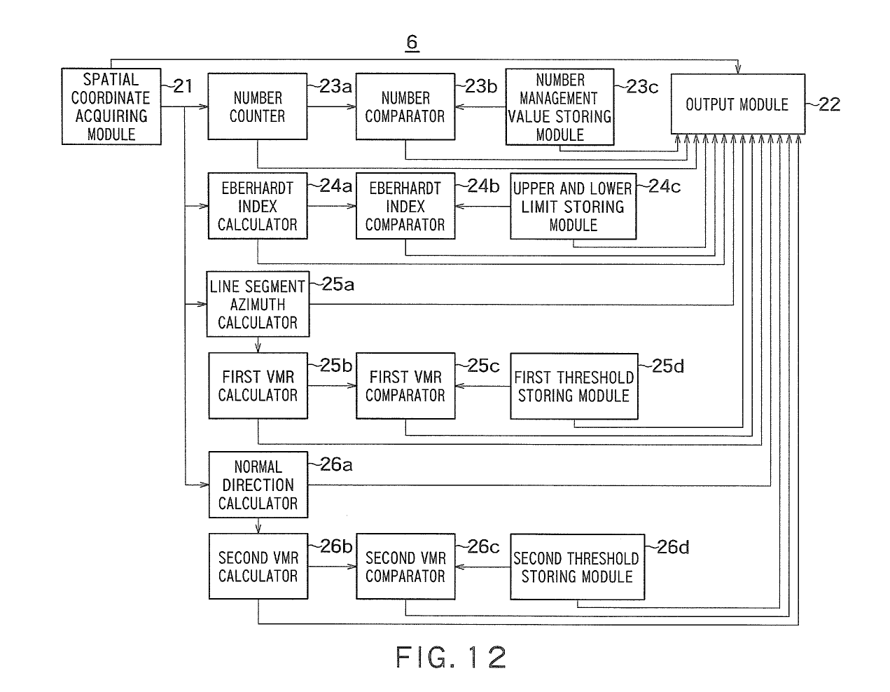

FIG. 12 is a block diagram illustrating a configuration of the structural analysis apparatus 6 of the second embodiment.

The structural analysis apparatus 6 of the present embodiment includes a space coordinate acquiring module 21 as an example of the coordinate acquiring module, an output module 22, a number counter 23a, a number comparator 23b, a number management value storing module 23c, an Eberhardt index calculator 24a, an Eberhardt index comparator 24b, and an upper and lower limit storing module 24c.

The structural analysis apparatus 6 of the present embodiment further includes a line segment azimuth calculator 25a as an example of the object pair generator and the azimuth calculator, a first VMR calculator 25b as an example of the first factor calculator, a first VMR comparator 25c as an example of the first comparator, and a first threshold storing module 25d.

The structural analysis apparatus 6 of the present embodiment still further includes a normal direction calculator 26a as an example of the object group generator and a normal direction calculator, a second VMR calculator 26b as an example of a second factor calculator, a second VMR comparator 26c as an example of a second comparator, and a second threshold storing module 26d.

The space coordinate acquiring module 21 acquires the space coordinate data on the atoms 14 in the sample 13 in step S1.

The number counter 23a counts the number N of the specific atoms 14 in the sample 13 in step S2. The number comparator 23b compares the number N and the number management value N_{U} stored in the number management value storing module 23c in step S4, and executes the process according to the result of the comparison between these values.

The Eberhardt index calculator 24a calculates the Eberhardt index E of the specific atoms 14 in the sample 13 in step S3. The Eberhardt index comparator 24b compares the Eberhardt index E and the upper and lower limits E_{U} and E_{L} stored in the upper and lower limit storing module 24c in step S5, and executes the process according to the result of the comparison between these values.

The line segment azimuth calculator 25a generates the plural atom pairs in step S6, and calculates the azimuth of the line segment connecting the atoms 14 of each atom pair. The first VMR calculator 25b calculates the first variance/mean ratio (VMR) D of the atom pairs in step S6. The first VMR comparator 25c compares the first variance/mean ratio D and the first threshold D_{L} stored in the first threshold storing module 25d in step S7, and executes the process according to the result of the comparison between these values. For example, the first VMR comparator 25c displays the result of the comparison between the first variance/mean ratio D and the first threshold D_{L} on the screen through the output module 22.

The normal direction calculator 26a generates the plural atomic groups in step S8, and calculates the normal direction of each triangle formed by the atoms 14 of each atomic group. The second VMR calculator 26b calculates the second variance/mean ratio (VMR) P of the atomic groups in step S8. The second VMR comparator 26c compares the second variance/mean ratio P and the second threshold P_{L} stored in the second threshold storing module 26d in step S9, and executes the process according to the result of the comparison between these values. For example, the second VMR comparator 26c displays the result of the comparison between the second variance/mean ratio P and the second threshold P_{L} on the screen through the output module 22.

The output module 22 outputs data received from these blocks. For example, the output module 22 may display the data received from these blocks on the screen, may store the data in a storage device, or may transmit the data to the outside through a communications device.

As described above, the present embodiment generates the plural atom pairs, calculates the first variance/mean ratio D of the azimuths of these atom pairs, and uses the first variance/mean ratio D to analyze the distribution of atoms 14. In addition, the present embodiment generates the plural atomic groups, calculates the second variance/mean ratio P of the normal directions of these atomic groups, and uses the second variance/mean ratio P to analyze the distribution of atoms 14.

Consequently, the present embodiment makes it possible to analyze the spatial distribution of the atoms 14 based on statistical evidence, specifically, makes it possible to discriminate between a linear distribution and a planar distribution by the first variance/mean ratio D or the second variance/mean ratio P.

In addition, the present embodiment makes it possible to analyze the aggregative state of the atoms 14 in detail by calculating the Eberhardt index E, the first variance/mean ratio D and the second variance/mean ratio P. For example, the present embodiment makes it possible to gain the knowledge that the specific atoms 14 are separated out on the particle boundary interface of polycrystal, without having to conduct any complicated graphical analysis.

The flowcharts of FIGS. 2 and 8 are merely examples of the failure detection method of the first embodiment and the structural analysis method of the second embodiment. These methods may therefore be carried out according to other flowcharts. For example, the management of the number N, management by the Eberhardt index E, management by the first variance/mean ratio D, and management by the second variance/mean ratio P may be performed independently. In addition, the processes of steps S11 to S15 and steps S21 to S26 may be replaced with other processes.

The failure detection method of the first embodiment and the structural analysis method of the second embodiment may be carried out on a computer by allowing the computer to execute computer programs for carrying out these methods. In this case, a computer-readable recording medium on which these programs are non-temporarily recorded may be prepared to install the programs in the computer from this recording medium. Furthermore, these programs may be downloaded through a network to install the programs in the computer.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. An object distribution analysis apparatus comprising:
a coordinate acquiring module configured to acquire coordinate data on plural objects;
an object pair generator configured to generate plural object pairs, each of which includes two objects among the plural objects;
an azimuth calculator configured to calculate an azimuth of a line segment connecting the objects of each object pair; and
a first factor calculator configured to calculate a first factor which depends on azimuths of line segments of the plural object pairs.

2. The apparatus of claim 1, further comprising a first comparator configured to compare the first factor and a first threshold, and to execute a process according to a result of the comparison between the first factor and the first threshold.

3. The apparatus of claim 1, wherein the first factor depends on a mean and a variance of the azimuths of the line segments of the plural object pairs.

4. The apparatus of claim 1, wherein the object pair generator calculates a distance between the objects based on the coordinate data, and generates the object pairs based on the distance between the objects.

5. The apparatus of claim 1, wherein the objects are particles or defects on a wafer.

6. The apparatus of claim 1, further comprising:
an object group generator configured to generate plural object groups, each of which includes three objects among the plural objects;
a normal direction calculator configured to calculate a normal direction of a triangle formed by the objects of each object group; and
a second factor calculator configured to calculate a second factor which depends on normal directions of triangles of the plural object groups.

7. The apparatus of claim 6, further comprising a second comparator configured to compare the second factor and a second threshold, and to execute a process according to a result of the comparison between the second factor and the second threshold.

8. The apparatus of claim 6, wherein the second factor depends on a mean and a variance of the normal directions of the triangles of the plural object groups.

9. The apparatus of claim 6, wherein the triangles are Delaunay triangles.

10. The apparatus of claim 6, wherein the objects are atoms in a sample to be analyzed using a three-dimensional atom probe.

11. The apparatus of claim 1, further comprising:
a number counter configured to count a number of the plural objects;
a number comparator configured to compare the number and a threshold;
an Eberhardt index calculator configured to calculate an Eberhardt index of the plural objects; and
an Eberhardt index comparator configured to compare the Eberhardt index and one or more thresholds.

12. An object distribution analysis method comprising:
acquiring coordinate data on plural objects;
generating plural object pairs, each of which includes two objects among the plural objects;
calculating an azimuth of a line segment connecting the objects of each object pair; and
calculating a first factor which depends on azimuths of line segments of the plural object pairs.

13. The method of claim 12, further comprising comparing the first factor and a first threshold, and executing a process according to a result of the comparison between the first factor and the first threshold.

14. The method of claim 12, wherein the first factor depends on a mean and a variance of the azimuths of the line segments of the plural object pairs.

15. The method of claim 12, further comprising calculating a distance between the objects based on the coordinate data, and generating the object pairs based on the distance between the objects.

16. The method of claim 12, further comprising:
generating plural object groups, each of which includes three objects among the plural objects;
calculating a normal direction of a triangle formed by the objects of each object group; and
calculating a second factor which depends on normal directions of triangles of the plural object groups.

17. The method of claim 16, further comprising comparing the second factor and a second threshold, and executing a process according to a result of the comparison between the second factor and the second threshold.

18. The method of claim 16, wherein the second factor depends on a mean and a variance of the normal directions of the triangles of the plural object groups.

19. The method of claim 16, wherein the triangles are Delaunay triangles.

20. The method of claim 12, further comprising:
counting a number of the plural objects;
comparing the number and a threshold;
calculating an Eberhardt index of the plural objects; and
comparing the Eberhardt index and one or more thresholds.
